(19) United States
(12) Patent Application Publication
(10) Pub. No.: US 2009/0163173 A1
(43) Pub. Date: Jun. 25, 2009

(54) UNAUTHORIZED CALL ACTIVITY DETECTION IN A CELLULAR COMMUNICATION SYSTEM

(75) Inventor: Timothy D. Williams, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/995,121

(22) PCT Filed: Jun. 8, 2006
(86) PCT No.: PCT/US06/22290

§ 371 Date: Jan. 9, 2008

(30) Foreign Application Priority Data
Aug. 5, 2005 (GB) 0516160.9

(51) Int. Cl. H04W 12/12

(52) U.S. Cl. 455/410

(57) ABSTRACT

A cellular communication system (100) includes a subscriber unit (101) having an associated subscriber identity. The subscriber unit (101) transmits call log data over an air interface communication link. The call log data is generated locally in the subscriber unit (101). A billing processor (117) generates billing data for the subscriber unit (101). The billing data can be generated in the fixed network in response to characteristics and the operation of the fixed network. A call activity processor (119) comprises a call log data processor (203) which receives the call log data from the cellular subscriber unit (101) and a billing data processor (205) which receives subscriber unit specific billing data from the billing processor (117). A comparison processor (207) then compares the billing data and the call log data and determines if unauthorized call activity has occurred.

### FIELD OF THE INVENTION

The invention relates to detection of unauthorized call activity in a cellular communication system, and in particular, but not exclusively to detection of fraudulent call activity.

### BACKGROUND OF THE INVENTION

In the last decade, cellular communication systems providing communication services to mobile users have become increasingly popular and now form a major part of the communication infrastructure of many countries.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

In the last years, 3rd generation systems have been rolled out to further enhance the communication services provided to mobile users. One such system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

However, in line with the increasing popularity of the cellular communication systems, an increasing problem with fraud has been experienced. For example, fraudulent users have been known to assume an identity of another user when using the cellular communication system thereby resulting in the call charges being assigned to the legitimate user for calls made by the fraudulent user.

Such fraudulent use is very difficult to detect as the call appears genuine to the cellular communication system. Therefore, in order to detect such fraud, a legitimate user must detect that he is being charged for calls that he did not make.

However, although the user may be able to detect such information by reviewing the charging statements showing such an approach has a number of disadvantages.

For example, the process is associated with an inherent delay. Typically statements are sent to a user at a monthly interval resulting in a fraudulent user being able to continue the abuse for up to a month before the fraudulent use can be detected. Furthermore, users typically do not always review call charging statements when they are received and may indeed ignore such statements thereby resulting in a potentially very long delay before the detection of the fraudulent use.

Furthermore, the process is cumbersome and requires the user to manually scrutinise the billing statements. This is inconvenient and cumbersome to the user and will often result in the user not reviewing the statement in detail.

Also, the approach requires that a user is able to determine if the listed calls are indeed made by him. However, such detection relies on the user's ability to remember his exact call activity, which will typically result in only extreme deviations from the usage of the legitimate user being detected.

Furthermore, even if the user is able to detect the fraudulent use, it is difficult for the user to prove that he did not make the calls in question and it is difficult for a network operator to independently verify that the unauthorized call activity has indeed taken place.

Typically, the conventional approach thus only results in extreme and highly unusual fraudulent use being detected, and detection of fraudulent behaviour which may resemble a usage pattern of the user may be difficult to detect. For example, the user will typically not detect fraudulent use if this is limited to short calls of low value.

Hence, an improved system for detecting an unauthorised call activity would be advantageous and in particular a system allowing increased flexibility, improved performance, reduced inconvenience to a user, facilitated detection, faster detection, network based detection or verification, an objective detection and/or improved detection of an unauthorised call activity would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for detection of unauthorized call activity in a cellular communication system, the apparatus comprising: means for receiving call log data from a cellular subscriber unit having an associated subscriber identity over an air interface communication link; means for receiving subscriber unit specific billing data from a billing processor of the cellular communication system; detection means for detecting an unauthorized call activity for the associated subscriber identity in response to a comparison of the billing data and the call log data.

The invention may allow an improved detection of unauthorized call activity in a cellular communication system. The invention may allow a detection of fraud and may facilitate determination of whether a given activity is unauthorized or performed by the legitimate user. A facilitated unauthorized call activity is achieved obviating the requirement for a manual post evaluation. The invention may allow unauthorized call activity to be performed more frequently and may result in the period of time an unauthorized call activity can take place before detection to be reduced substantially. The invention may allow detection of unauthorized call activity resulting in small variations from a normal behaviour to be more easily detected. The invention may further allow a network operator to independently detect or verify unauthorized call activity without relying on the subjective statements of a user.

The subscriber identity may be an identity associated with the subscriber and/or with the subscriber unit. The subscriber identity may for example be a user identity stored in a Subscriber Identity Module (SIM) card as known from e.g. GSM and UMTS. The unauthorized call activity may for example be an unauthorized voice call, a circuit switched data call or a packet data call (session). The call log data may be data generated locally in the subscriber unit. The billing data may be generated in the network. Thus, the call log data may be generated based on characteristics detected in the subscriber unit and the billing data may be generated based on characteristics detected in the fixed network of the cellular communication system.

According to an optional feature, the detection means is arranged to detect the unauthorized call activity in response to a discrepancy between call log data and billing data for an individual call.

The detection means may compare call characteristics for a single call stored in the billing data with the corresponding characteristics for the call stored in the call log data. If the stored values are not sufficiently close according to a suitable criterion, an unauthorized call activity may be determined to have occurred. Specifically, an unauthorized call activity may be deemed to have occurred if the billing data comprises data for a call that the call log data does not comprise data for. The detection means may proceed to evaluate data for more or all calls of the billing data and/or the call log data. This may allow a reliable and efficient unauthorized call activity detection.

According to an optional feature, the discrepancy is a discrepancy of at least one characteristic selected from the group consisting of: a call start time; a call end time; a call duration; an amount of communicated data; and at least one subscriber identity involved in the call.

This may allow an efficient, reliable and/or low complexity unauthorized call activity detection.

According to an optional feature, the air interface communication link is an air interface communication link of the cellular communication system.

The apparatus may be implemented as part of the fixed network of the cellular communication system and may in particular be integrated with the billing processor. The call log data may for example be transmitted over a standard uplink communication service of the cellular communication system. This may allow a practical implementation and may allow an operator of a cellular network to reduce fraud and improve the customer service.

According to an optional feature, the air interface communication link is not a communication link of the cellular communication system.

The communication link may for example be a communication link of a short range air interface such as a Bluetooth™ connection or a Wireless Local Area Network (WLAN) connection. The apparatus may be implemented independently of the cellular communication system and may receive the billing data through an air interface communication link of the cellular communication system. This may allow an efficient and practical implementation and may allow a user to implement the apparatus without any other requirement of the cellular communication system than a provision of the billing data.

According to an optional feature, the apparatus further comprises means for receiving the call log data by a packet data service of the cellular communication system.

This may allow a practical and efficient implementation. The packet data service may for example be a General Packet Radio Service (GPRS).

According to an optional feature, the apparatus further comprises means for sending a request for the call log data to the cellular subscriber unit. The request may be sent in response to receiving billing data for the subscriber identity.

This may provide an efficient system wherein the call log data is uploaded to the apparatus as and when it is needed.

According to an optional feature, the apparatus further comprises means for receiving a first location estimate from the cellular subscriber unit and wherein the detection means is further arranged to detect the unauthorized call activity in response to the first location estimate.

This may allow improved detection. Specifically, the feature may allow an improved accuracy of the detection of unauthorized call activity. The first location estimate may for example be determined at the subscriber unit by a resident Global Positioning System (GPS) receiver or by a location processor determining the location in response to signals received from the base stations of the cellular communication system.

According to an optional feature, the apparatus further comprises means for receiving a second location estimate derived by a fixed network of the cellular communication system; and the detection means is further arranged to detect the unauthorized call activity in response to the second location estimate.

This may allow improved detection. Specifically, the feature may allow an improved accuracy of the detection of unauthorized call activity. The second location estimate may for example be determined at the fixed network by a location processor determining the location in response to signals received from the subscriber unit. The second location estimate may for example be a coarse location estimate such as a serving cell indication.

According to an optional feature, the detection means is arranged to detect the unauthorized call activity in response a comparison of the first and second location estimates.

This may allow improved unauthorized call activity detection and may in particular allow discrepancies between locations to be taken into account when detecting an unauthorized call activity.

According to an optional feature, the apparatus further comprises means for disallowing call access for the subscriber identity in response to a detection of the unauthorized call activity.

This may prevent unauthorised activity continuing and may allow an early detection of unauthorized call activity thereby effectively reducing the amount of unauthorized call activity in a cellular communication system.

According to a second aspect of the invention there is provided, a cellular communication system comprising: a subscriber unit having an associated subscriber identity and comprising means for transmitting call log data over an air interface communication link; a billing processor for generating billing data; and a processor comprising: means for receiving the call log data from the cellular subscriber unit, means for receiving subscriber unit specific billing data from the billing processor, and detection means for detecting an unauthorized call activity for the associated subscriber identity in response to a comparison the billing data and call log data.

According to an optional feature, the subscriber unit comprises means for initiating a communication of the call log data by initiating a call to a predetermined telephone number; and the cellular communication system further comprises means for routing the call log data to the processor in response to the predetermined telephone number.

This may allow a practical and user friendly means of uploading the call log data.

According to an optional feature, the cellular communication system further comprises means for requesting the call log data from the subscriber unit in response to a detection of time overlapping call activity of two subscriber units using the subscriber identity.

This may improve unauthorized call activity detection and may prevent fraudulent access of the cellular communication system. In particular, it may allow a conflicting access to be resolved with short delay.

According to an optional feature, the processor comprises an authentication processor for registering a new subscriber unit and associated subscriber identity.

This may facilitate introduction of new subscriber units and may prevent calls by new subscriber units to be detected as unauthorized call activity.

According to an optional feature, the cellular communication system is a Global System for Mobile communication (GSM) cellular communication system.

The invention may allow improved unauthorized call activity detection for a GSM cellular communication system.

According to an optional feature, the cellular communication system is a Universal Mobile Telecommunication System (UMTS).

The invention may allow improved unauthorized call activity detection for a UMTS cellular communication system.

According to a third aspect of the invention there is provided a method of detecting unauthorized call activity in a cellular communication system, the method comprising: receiving call log data from a cellular subscriber unit having an associated subscriber identity over an air interface communication link; receiving subscriber unit specific billing data from a billing processor of the cellular communication system; and detecting an unauthorized call activity for the associated subscriber identity in response to a comparison of the billing data and the call log data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system 100 in which embodiments of the invention may be employed;

FIG. 2 illustrates an apparatus for detection of unauthorized call activity in accordance with some embodiments of the invention; and

FIG. 3 illustrates a method of detecting unauthorized call activity in a cellular communication system in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied in connection with many other cellular communication systems including for example a UMTS cellular communication system.

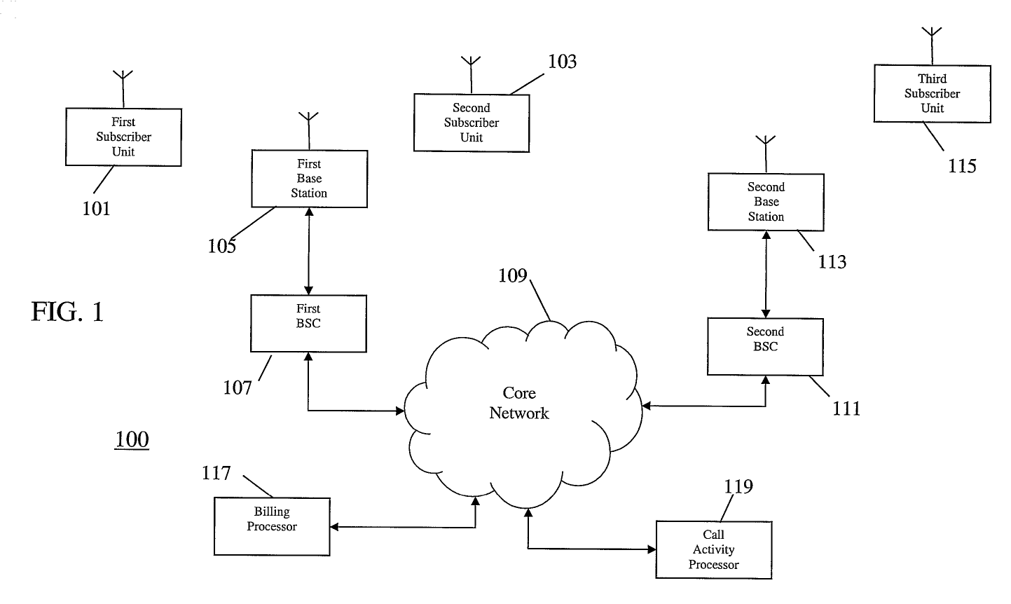

FIG. 1 illustrates an example of a cellular communication system 100 in which embodiments of the invention may be employed.

In a cellular communication system, a geographical region is divided into a number of cells each of which is served by a base station. The base stations are interconnected by a fixed network which can communicate data between the base stations. A subscriber unit (e.g. a User Equipment (UE) or a mobile station) is served via a radio communication link by the base station of the cell within which the subscriber unit is situated.

As a subscriber unit moves, it may move from the coverage of one base station to the coverage of another, i.e. from one cell to another. As the subscriber unit moves towards a base station, it enters a region of overlapping coverage of two base stations and within this overlap region it changes to be supported by the new base station. As the subscriber unit moves further into the new cell, it continues to be supported by the new base station. This is known as a handover or handoff of a subscriber unit between cells.

A typical cellular communication system extends coverage over typically an entire country and comprises hundreds or even thousands of cells supporting thousands or even millions of subscriber units. Communication from a subscriber unit to a base station is known as uplink, and communication from a base station to a subscriber unit is known as downlink.

In the example of FIG. 1, a first subscriber unit 101 and a second subscriber unit 103 are in a first cell supported by a first base station 105.

The first base station 105 is coupled to a first Base Station Controller (BSC) 107. A BSC performs many of the control functions related to the air interface including radio resource management and routing of data to and from appropriate base stations.

The first BSC 107 is coupled to a core network 109. A core network interconnects BSCs and is operable to route data between any two BSCs, thereby enabling a subscriber unit in a cell to communicate with a subscriber unit in any other cell. In addition, a core network comprises gateway functions for interconnecting to external networks such as the Public Switched Telephone Network (PSTN), thereby allowing subscriber units to communicate with landline telephones and other communication terminals connected by a landline. Furthermore, the core network comprises much of the functionality required for managing a conventional cellular communication network including functionality for routing data, admission control, resource allocation, subscriber billing, subscriber unit authentication etc. The core network may specifically comprise one or more Mobile Switching Centres (MSCs).

The core network 109 is further coupled to a second BSC 111 which is coupled to a second base station 113. The second base station 113 supports a third subscriber unit 115.

In the system of FIG. 1, a legitimate user is assigned an identity which is used for recognising the user and for determining billing data for the user. Specifically, a first user of the first subscriber unit 101 has a subscriber identity specified in a Subscriber Identity Module (SIM) as is well known from GSM cellular communication systems.

As a specific example, the first subscriber unit 101 may initiate a call to the third subscriber unit 115. In order to do so, the subscriber identity from the SIM is transmitted to the first base station 105. This user identity is together with call characteristics fed to a billing processor 117 of the core network 109 (for clarity shown separate to the core network 109 in FIG. 1). This information is then used to generate billing data for charging the first user.

However, if a fraudulent user obtains access to the subscriber identity, for example by an illegal duplication of the SIM card, this can be used to access the cellular communication system. For example, if a second user initiates a call from the second subscriber unit 103 using a fraudulently obtained SIM card, this access will be indistinguishable from a genuine access from the first user. Accordingly, the call characteristics may together with the first user's subscriber identity be fed to the billing processor 117 resulting in the first user being charged for the call made fraudulently be the second user.

In order to mitigate this problem, the system of FIG. 1 comprises a call activity processor 119 which comprises means for detecting unauthorized call activity in the system, and which in the described example is particularly arranged to detect unauthorized call activity for the subscriber identity of the first user.

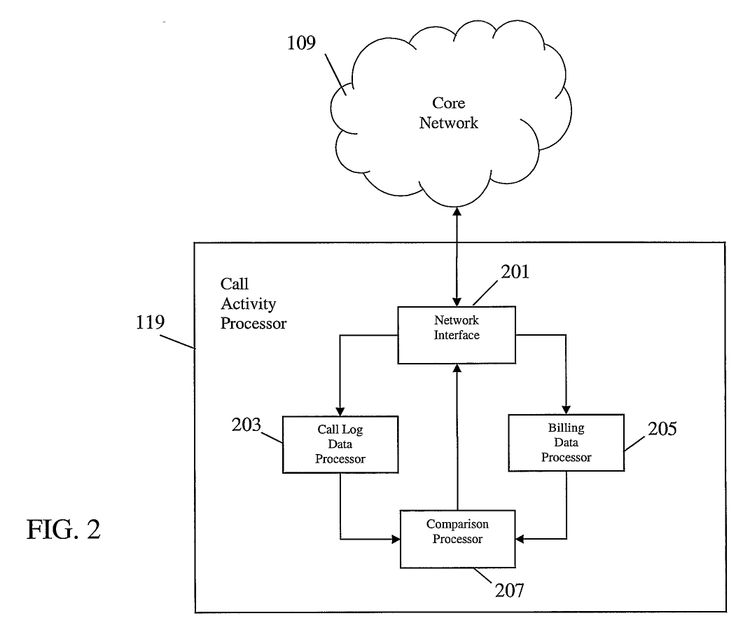

FIG. 2 illustrates the call activity processor 119 in more detail.

The call activity processor 119 comprises a network interface 201 which interfaces to the core network 109 and which specifically is arranged to receive and transmit data to other elements of the fixed network or of the cellular communication system as a whole.

The network interface 201 is coupled to a call log data processor 203 which is arranged to receive call log data from at least the first subscriber unit 101. The call log data is received through the core network, the first BSC 107, the first base station 105 and over the air interface communication link between the first base station 105 and the first subscriber unit 101. Thus, in the example, the call log data is received over an air interface communication link of the air interface of the cellular communication system.

The communication of the call log data can specifically be achieved by using a packet data service of the cellular communication system. The subscriber unit can set up a packet data session with the call activity processor 119 using e.g. a GPRS packet data service. This can provide a very efficient communication and allows the system to easily be added to already deployed systems.

Most mobile stations and other subscriber units of current cellular communication systems tend to locally log the call activity of the subscriber unit. E.g. a mobile phone telephone will typically store the call duration and a called telephone number for all the outgoing calls made by the mobile phone. This call log data is stored in the mobile station and is typically used by a user of a mobile phone to review the past call activity of the mobile phone.

However, in accordance with the embodiments of FIGS. 1 and 2, such subscriber unit generated call log data is further uploaded to the fixed network and fed to the call activity processor 119 where it will be received by the call log data processor 203.

It will be appreciated that the exact call log data which is stored or uploaded to the fixed network will depend on the specific embodiment. In many embodiments, the call log data will comprise one or more of the following characteristics:
A call start time indicating when a given call was initiated.
A call end time indicating when a given call was terminated.
A call duration indicating the duration of a given call.
An amount of communicated data indicating how much data was transmitted and/or received during a call. This parameter may be particularly suitable for scenarios wherein the call is a packet data session.
An identity of at least one other cellular subscriber unit involved in the call. For example, the phone number or user identity of a called party of a telephone call may be recorded.

The call activity processor 119 furthermore comprises a billing data processor 205 which is arranged to receive subscriber unit specific billing data from the billing processor 117. The billing data processor 205 receives the data through the core network 109 and the billing processor 117 is specifically arranged to compile billing data relating to call activity for an individual subscriber identity and send this to the call activity processor 119 where it is received by the billing data processor 205.

It will be appreciated that the exact billing data which is received by the billing processor 117 will depend on the specific embodiment. In many embodiments, the billing data will comprise one or more of the following characteristics:
A call start time indicating when a given call was initiated.
A call end time indicating when a given call was terminated.
A call duration indicating the duration of a given call.
An amount of communicated data indicating how much data was received and/or transmitted during a call. This parameter may be particularly suitable for scenarios wherein the call is a packet data session.
An identity of at least one other cellular subscriber unit involved in the call. For example, the phone number or user identity of a called party of a telephone call may be recorded.

The call log data processor 203 and the billing data processor 205 are coupled to a comparison processor 207 which is arranged to detect an unauthorized call activity for the associated subscriber identity in response to a comparison of the billing data and the call log data. The call log data processor 203 and the billing data processor 205 may be arranged to process the call log data and the billing data respectively before it is forwarded to the comparison processor 207. For example, the call log data processor 203 and the billing data processor 205 may select and format individual data parameters so as to allow these to be directly compared.

The comparison processor 207 may simply compare the call log data and the billing data for individual calls. For example, if the billing data comprises information for calls which are not comprised in the call log data, this is an indication of the calls being made without the involvement of the first subscriber unit 101 and may thus be detected as a (potential) unauthorized call activity.

As a specific example, characteristics of the call made by the first subscriber unit 101 will be recorded locally in the call log data of the first subscriber unit 101. In addition, call characteristics will be included in the billing data used for charging the first user. However, the call made by the second subscriber unit 103 fraudulently using the subscriber identity of the SIM card of the first subscriber unit 101 will also be recorded in the billing data for the subscriber identity of first subscriber unit 101, but will not be recorded in the call log data from the first subscriber unit 101. Thus, the fraudulent call from the second subscriber unit can automatically be detected by the cellular communication system without requiring any activity or even knowledge by the first user of this detection.

Furthermore, the detection may occur with a short delay and a high probability of detection which does not rely on subjective evaluation or human characteristics such as an accurate recollection of the previous call activity. Thus, by uploading call log data such that independently and separately generated call activity data can be compared, improved unauthorized call activity detection is achieved. Specifically, the automatic comparison of data generated locally in the subscriber unit with data generated by the fixed network allows for reliable detection of unauthorized call activity.

Specifically, any kind of discrepancy between the call log data generated by the subscriber unit based on information of the subscriber unit's activity and the billing data based on the network activity for the subscriber identity may be indicative of an unauthorized call activity. However, a discrepancy may in some embodiments occur for other reasons. E.g. a discrepancy may arise due to the memory of the subscriber unit being insufficient to store all call log data before uploading. Accordingly, in many embodiments, the comparison processor 207 may further evaluate the received data and may include other characteristics and parameters in the detection of unauthorized call activity. For example, the comparison processor 207 may determine that a discrepancy between the call log data and the billing data is only an unauthorized call activity if the discrepancy relates to a time interval for which call log data was successfully stored and uploaded to the call activity processor 119.

It will be appreciated that any suitable detection of a discrepancy can be used. For example, a discrepancy between a start time, end time and/or duration of a call may be used as an indication of an unauthorized call activity. In particular, any such entry in the billing data not matching the entry in the call log data may be taken as an indication of an unauthorized call activity.

As another example, data communication by the first user may generally be limited to low data rate applications, such as Internet browsing. However, if the billing data comprises an indication of a data session call with a high amount of communicated data, this may be an indication that the call is an unauthorized call activity. As yet another example, billing data comprising a call involving a specific subscriber identity or telephone number, such as a premium rate number, may be taken as an indication of an unauthorized call activity. The parameters of such criteria can be set in response to the call log data. Specifically, normal behaviour parameters may be determined in response to the call log data and if the billing data indicates activity exceeding these parameters, this may be taken as an indication of an unauthorized call activity.

Furthermore, it will be appreciated that the operation of the system in response to the detection of an unauthorized call activity may depend on the characteristics and preferences for the individual system. For example, in many embodiments, the call activity processor 119 can comprise functionality for causing call access for the subscriber identity to be disallowed when an unauthorized call activity is detected for the subscriber identity.

In the example of FIG. 2, the comparison processor 207 furthermore comprises means for generating a disallowance message in response to the detection of the unauthorized call activity. The comparison processor 207 is coupled to the network interface 201 and can through this send the disallowance message to an element of the core network 109 involved in call setups for the corresponding subscriber identity. For example, if the call activity of the second subscriber unit 103 using the subscriber identity of the first user is detected, the comparison processor 207 generates a message which is sent to a Home Location Register (HLR) (or a Visitor Location Register (VLR)) of the first subscriber unit 101. When receiving this message, the HLR records data that indicates that no call setups are allowed for this subscriber identity. Accordingly, future call setups will be terminated when the HLR is accessed as part of the setup process.

In the example, the comparison processor 207 furthermore generates a notification message, such as a Short Message Service (SMS) text, which is transmitted to the first subscriber unit 101 informing the first user of the detection of a presumed unauthorized call activity. In addition, the comparison processor 207 generates a notification message for the network operator.

In some embodiments, the call activity processor 119 can comprise means for requesting that the first subscriber unit 101 uploads the call log data. For example, the billing data can be collected by the billing processor 117 and sent to the call activity processor 119 at regular intervals (such as once per week or once per month). When the call activity processor 119 receives the billing data, the call activity processor 119 can send a message to the first subscriber unit 101 in response to which the first subscriber unit 101 transmits the call log data.

In some embodiments, the call activity processor 119 may further consider location information in determining if an unauthorized call activity has occurred.

For example, in some embodiments, the call activity processor 119 can receive location estimates from the subscriber units. This location estimate can for example be generated by a GPS receiver in the subscriber unit or can be determined by an algorithm detecting the time of arrival of downlink signals from transmitters at known locations as will be well known to the person skilled in the art.

Additionally or alternatively, the call activity processor 119 can receive a location estimate which is generated in the fixed network. This location estimate can be generated from uplink signals of the subscriber unit and can be generated without the involvement or knowledge of the subscriber unit. In some embodiments, this location estimate may be a very coarse location estimate, such as for example a location of a serving base station. Alternatively or additionally, a more accurate location estimate can be generated based on the time of arrival of the uplink signals from the subscriber unit at a plurality of base stations.

It will be appreciated that any suitable algorithm considering the location estimates may be used, and that in particular the unauthorized call activity detection may be in response to both the subscriber unit and the network based location estimates.

For example, if a location estimate is stored for every call made, a large variation in the location between calls may be an indication of an unauthorized call activity. E.g., if two calls made five minutes apart from two locations, say, 100 km apart, an unauthorized call activity is likely to have occurred as these cannot be from the same subscriber unit.

As another example, in some embodiments, the first subscriber unit 101 may attach a location estimate to the call data for the individual calls in the call log data. However, the second subscriber unit may not do so as the call activity is unauthorized. However, in this case, the location estimate may be determined by the fixed network without the knowledge of the second subscriber unit. A comparison between the location estimates from the subscriber unit and the network can then indicate that the calls are made from different locations thus providing a further indication of an unauthorized call activity.

It will be appreciated that the call log data upload may be achieved in different ways in different embodiments. In some embodiments, the first subscriber unit 101 can call a specific telephone number allocated to the call activity processor 119. When the call has been successfully established, the first subscriber unit 101 can automatically begin to upload the data. As another example, the first subscriber unit 101 can be a Wireless Application Protocol (WAP) enabled subscriber unit and the upload can be effected when the first user navigates to a specific predefined website resulting in the network automatically uploading the call log data from the first subscriber unit 101.

In some embodiments the cellular communication system comprises functionality for detecting that two calls are simultaneously setup for the same subscriber identity. If this occurs, it is likely that an unauthorized call activity is taking place and the uploading of call log data can be requested immediately to determine which of the calls is the legitimate call. In some systems, such as UMTS, where simultaneous calls are allowed for the same subscriber identity, the detection can further be in response to location estimates. Specifically, if the simultaneous calls occur from the same location, indicating that it is from the same subscriber unit, no action is taken but if the location estimates deviate sufficiently, the uploading of call log data is requested.

In some embodiments, the call activity processor 119 furthermore comprises functionality for registering a new subscriber unit and associated subscriber identity. Thus, when a user procures a new subscriber unit, he may access the call activity processor 119 to register the subscriber identity and registering for the service.

It will be appreciated that although the above description focuses on an embodiment wherein the call activity processor 119 is part of the cellular communication system, this may not be the case in other embodiments. For example, the call activity processor 119 may be an independent processing device, such as a personal computer, owned by the first user. The first subscriber unit 101 may comprise functionality for communicated with the call activity processor 119 over a short range standardised air interface, such as over a Bluetooth™ or IEEE 802.11 communication link. In addition, the call activity processor 119 may communicate with the billing processor 117 over an air interface link which could be an air interface link of the cellular communication system.

In such an embodiment, the call activity processor 119 may request that the first subscriber unit 101 transmits the call log data and that the billing processor 117 transmits the billing data. When this is received, the call activity processor 119 can compare the data to identify any unauthorized call activity. If any such activity is detected the user is be informed.

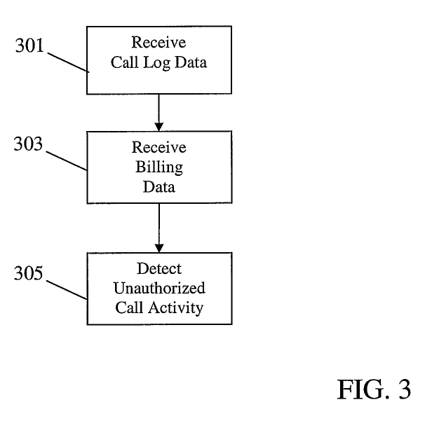

FIG. 3 illustrates an example of a method of detecting unauthorized call activity in a cellular communication system. The method may be applicable to the call activity processor 119 of FIGS. 1 and 2 and will be described with reference to this.

The method initiates in step 301 wherein the comparison processor 207 of the call activity processor 119 receives call log data from a cellular subscriber unit 101 having an associated subscriber identity over an air interface communication link.

Step 301 is followed by step 303 wherein the billing data processor 205 receives subscriber unit specific billing data from the billing processor 117 of the cellular communication system.

Step 303 is followed by step 305 wherein the comparison processor 207 detects an unauthorized call activity for the associated subscriber identity in response to a comparison of the billing data and the call log data.

The method may then return to step 301.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for detection of unauthorized call activity in a cellular communication system, the apparatus comprising:
means for receiving call log data from a cellular subscriber unit having an associated subscriber identity over an air interface communication link;
means for receiving subscriber unit specific billing data from a billing processor of the cellular communication system;
detection means for detecting an unauthorized call activity for the associated subscriber identity in response to a comparison of the billing data and the call log data.

2. The apparatus of claim 1 wherein the detection means is arranged to detect the unauthorized call activity in response to a discrepancy between call log data and billing data for an individual call.

3. The apparatus of claim 2 wherein the discrepancy is a discrepancy of at least one characteristic selected from the group consisting of: a call start time; a call end time; a call duration; an amount of communicated data; and at least one other subscriber identity involved in the call.

4. The apparatus of claim 1 further comprising means for receiving the call log data by a packet data service of the cellular communication system.

5. The apparatus of claim 1 further comprising means for sending a request for the call log data to the cellular subscriber unit.

6. The apparatus of claim 5 wherein the apparatus is arranged to send the request in response to receiving billing data for the subscriber identity.

7. The apparatus of claim 1 further comprising means for receiving a first location estimate from the cellular subscriber unit; and wherein the detection means is further arranged to detect the unauthorized call activity in response to the first location estimate.

8. The apparatus of claim 7 further comprising means for receiving a second location estimate derived by a fixed network of the cellular communication system; and wherein the detection means is further arranged to detect the unauthorized call activity in response to the second location estimate.

9. The apparatus of claim 1 further comprising means for disallowing call access for the subscriber identity in response to a detection of the unauthorized call activity.

10. A method of detecting unauthorized call activity in a cellular communication system, the method comprising:
receiving call log data from a cellular subscriber unit having an associated subscriber identity over an air interface communication link;
receiving subscriber unit specific billing data from a billing processor of the cellular communication system; and
detecting an unauthorized call activity for the associated subscriber identity in response to a comparison of the billing data and the call log data.
